(19) United States
(12) Patent Application Publication
(10) Pub. No.: US 2019/0344673 A1
(43) Pub. Date: Nov. 14, 2019

(54) Secondary Unit, a System for Inductive Power Transfer and a Method for Operating a Secondary Unit and a System for Inductive Power Transfer

(71) Applicant: Bombardier Primove GmbH, Berlin (DE)

(72) Inventors: Dirk Mühlenhoff, Mainz (DE); Peter Willimowski, Rossdorf (DE)

(21) Appl. No.: 16/307,246

(22) PCT Filed: Jun. 14, 2017
(86) PCT No.: PCT/EP2017/064485

§ 371 Date: Dec. 5, 2018

(30) Foreign Application Priority Data
Jun. 16, 2016 (GB) 1610477.0

(51) Int. Cl. B60L 53/12; B60L 53/38; B60L 53/66

(52) U.S. Cl. CPC B60L 53/12; B60L 53/66; B60L 53/38

(57) ABSTRACT

The invention relates to a secondary unit of a system for inductive power transfer to a vehicle (2), wherein the secondary unit (1) comprises at least one secondary-sided means for executing generic functions, wherein the secondary unit (1) comprises at least one vehicle-specific state management means, wherein an execution of the generic functions is controllable by the at least one state management means.

The invention relates to a secondary unit of a system for inductive power transfer to a vehicle and a system for inductive power transfer to the vehicle. Further, the invention relates to a method of operating such a secondary unit and such a system for inductive power transfer.

Electric vehicles, in particular a track-bound vehicle, and/or a road automobile, can be operated by electric energy which is transferred by means of an inductive power transfer. Such a vehicle may comprise a so-called receiving device adapted to receive an alternating electromagnetic field and to produce an alternating electric current by electromagnetic induction. Such a receiving device can comprise or provide a so-called secondary winding structure. Furthermore, such a vehicle can comprise a rectifier adapted to convert an alternating current (AC) to a direct current (DC). The DC can be used to charge a traction battery or to operate an electric machine. The rectifier converts the AC provided by the receiving device into the DC.

The inductive power transfer is usually performed using a primary unit which generates the alternating electromagnetic field by a primary winding structure and a secondary unit which comprises the receiving device for receiving said electromagnetic field. The primary unit and the secondary unit can e.g. each comprise a set of three-phase windings providing the aforementioned primary and secondary winding structure. A set of windings of the primary unit can be installed on the ground (primary windings) and can be fed by a wayside power converter (WPC). A set of windings of the secondary unit is installed on the vehicle. For example, the second set of windings can be attached underneath the vehicle, in the case of trams under some of its wagons. The first and the secondary side can be part of a high frequency transformer to transfer electric energy to the vehicle. This transfer can be done in a static state (when there is no movement of the vehicle) and in a dynamic state (when the vehicle moves).

U.S. Pat. No. 7,454,170 B2 discloses an inductive transmission system for inductive transmission of power and full duplex data signals between first and second devices. The transmission system includes a bi-directional inductive channel between the two devices, a transmitter for transmitting a power signal at a first frequency from the first device to the second device over the inductive channel, a first modulating device for modulating a first data signal at a first modulation frequency, and a second modulating device for modulating a second data signal at a second modulation frequency. Further, the transmitters transmit the modulated first data signals from the first device to the second device over the inductive channel and transmit the modulated second data signals from the second device to the first device over the inductive channel. The first modulation frequency and the second modulation frequency are at least a factor two apart.

Inductive power transfer usually requires a correct positioning of a vehicle-sided secondary winding structure relative to a primary winding structure in order to maximize the amount of transfer power but also in order to meet safety requirements and ensure an electromagnetic compatibility.

WO 2011/127455 A2 describes a wireless charging and wireless power alignment of wireless power antennas associated with a vehicle.

WO 2014/023595 A2 discloses a vehicle and an induction charging unit, wherein the induction charging unit comprises a primary coil and the vehicle comprises a secondary coil. Further, in the charging position, the secondary coil is located in a preferred spatial position range with respect to the primary coil with the result that, in order to set the charging position, the system determines, by means of an electromagnetic distance and angle measurement using triangulation, a location which describes a time-dependent spatial position of the secondary coil with respect to the primary coil. The system detects, by means of the location and the charging position, at least one partial driving direction along which the location of a charging position can be approached.

The documents disclose communication antennas of an inductive power transfer (IPT) unit, namely the primary unit or the secondary unit.

In general, the systems for inductive power transfer comprise two separate units, the primary unit and the secondary unit. The secondary unit is mechanically connected to the vehicle. Further, the secondary unit is connected to a communication system of the vehicle, e.g. a bus system of the vehicle. In other words, the secondary unit is connected to the vehicle via electric and data transmission connecting means. The primary unit is not mechanically or electrically connected to the vehicle.

If the vehicle is to be provided with an inductive power transfer option, an operating software of the secondary unit or the system for inductive power transfer has to be adapted to each vehicle. The operating software can be adapted to each vehicle type. A vehicle type can also be denoted as vehicle model. Different types of vehicles can differ in at least one system architecture component. A system architecture of a vehicle type can e.g. comprise components such as controllers or control units, sensors and actuators. Further, the system architecture of a vehicle type can comprise communication interfaces providing a data or signal connection between such components. The data or signal connection can be a wired or a wireless connection.

Furthermore, separate vehicle manufactures can require different system behaviour and different communication interfaces of the secondary unit.

An operating software can provide software-based functions which can be executed by the hardware components of the system. By executing these functions, the system behavior as a whole and an individual behavior of each component can be controlled. Furthermore, a communication between hardware components can be controlled by executing functions.

There is the technical problem of providing a primary and a secondary unit for a system for inductive power transfer to a vehicle, a system for inductive power transfer to a vehicle and methods for operating such a secondary unit and such a system and a vehicle fleet which provide a larger application area of the secondary unit and the system for inductive power transfer.

The solution is provided by the subject-matter of the independent claims 1, 11, 14, 20, 23 and 26. Further advantageous embodiments are provided by the subject-matter of the dependent claims.

A secondary unit of an inductive power transfer system for electrically powering a vehicle is proposed. The secondary unit can comprise a secondary winding structure for receiving an alternating electromagnetic field. Further, the secondary unit can comprise a rectifier for rectifying the alternating output voltage provided by the secondary winding structure upon reception of the alternating electromagnetic field. Further, the secondary unit can comprise a current sensor for sensing a DC output current provided by the rectifier. The DC output current can e.g. be a charging current, if the rectifier is electrically connected to an energy storage means of the vehicle. Further, the secondary unit can comprise a secondary-sided control unit.

In the context of this invention, the term “secondary-sided” relates to parts or structures that are arranged at the site or vehicle of the inductive power transfer system to which the power is transferred to. The term “secondary-sided” can mean that the respective element is arranged in a fixed position relative to the secondary winding structure. In particular, the term “secondary-sided” can mean that the respective element can be part of the secondary unit. Correspondingly, the term “primary-sided” relates to parts or structures that are arranged at the wayside of the inductive power transfer system from which the power is transmitted, i.e. at which the alternating electromagnetic field emanated. The term “primary-sided” can mean that the respective element is arranged fixed in position relative to the primary winding structure. In particular, the term “primary-sided” can mean that the respective element is part of the primary unit. In most applications, the primary, i.e. “primary-sided”, unit is arranged at the wayside of the road or track, at which the electromagnetic field is emanated and the secondary, i.e. “secondary-sided”, unit is a vehicle pick-up unit. Solutions for both stationary and movable primary and secondary units exist.

The secondary unit comprises at least one secondary-sided means for executing generic functions. Generic functions can be generic software functions. Generic software functions can be executed by executing software-based code. This means that generic software functions can be provided by software design. Alternatively, generic functions can be hardcoded, i.e. functions provided by a certain hardware layout. The secondary-sided means for executing a generic function can be provided by at least one control unit, in particular by at least one microcontroller. The term “generic” can mean that the function is identical in respect to a set of parameters used for the execution of said function for multiple, in particular different, secondary units or for multiple, in particular different, vehicles to which the secondary unit can be connected. In particular, generic functions are identical for different vehicles, in particular different vehicles of different vehicle types. In other words, a generic function can be a vehicle-unspecific function.

Generic functions, however, can also be different for vehicles of different vehicle types. In other words, a generic function can also be a vehicle type-specific function. That functions are identical can mean that the functions are implemented identically or that identical functions are implemented. That functions are different can mean that functions are implemented different or that different functions are implemented.

Examples of used parameters are input magnetic flux, induced alternating current, frequency of the induced alternating current, induced voltage, frequency of the induced voltage, rectification current, rectification voltage, rectification type, secondary-sided impedance, secondary-sided capacity, required total load voltage, required total load current, number of load current outputs, sensor information, monitoring output.

In particular, the software or code which is executed in order to execute the generic function is identical with respect to the set of used parameters for multiple secondary units, in particular for secondary units of different vehicles, more particular for secondary units of different vehicles of one vehicle type. In other words, the generic function is implemented similarly for multiple secondary units, however different subsets of the set of used parameters may be used when implemented on different vehicle types. In particular, the generic function can be a vehicle-independent function. It is, however, possible that the generic function is a vehicle-type dependent function. By executing the generic function a desired operation of or within the secondary unit or a system comprising the secondary unit can be performed. For example, a charging operation of a vehicle-sided energy storage means can be controlled by executing at least one generic function.

A generic function can require at least one input, e.g. at least one input signal. The input can be provided as an input parameter. The input or input signal preferably has a generic format, wherein the same generic format can be used by components of at least two different vehicle types. Further, the generic function can provide at least one output, e.g. at least one output signal. The output or output signal of a generic function can also have the generic format. The execution of a generic function can further be triggered by at least one trigger signal with a generic format.

Further, a generic function can denote or comprise a set of multiple generic sub functions.

A generic function can be executed by using a set of parameters, wherein the set is dependent on the vehicle type it is implemented on. The set, however, can be changed or altered, in particular during the lifetime or during the course of a given period of time. Further, it is possible to use only a subset of the set of used parameters. This may depend on a single input date from the vehicle. The input date may comprise information about the vehicle type.

A vehicle specific function, in particular in contrast to a generic function, uses a pre-defined set of parameters which set is not altered during the lifetime of the vehicle or during the course of a given period of time. That can mean that the set of used parameters is at least fixed for the time period from a first maintenance date to a second maintenance date.

According to the invention, the secondary unit comprises at least one vehicle-specific state management means, wherein an execution of the generic functions is controllable or manageable by the at least one vehicle-specific state management means. It is, of course, possible that also the execution of non-generic, e.g. vehicle-specific, functions can be controlled by the vehicle-specific state management means. In other words, the vehicle-specific state management means allows the control of a vehicle-specific state.

A state management means, in particular a vehicle-specific and/or a generic state management means, can be e.g. be provided by a processing unit. The processing unit can e.g. be a microcontroller or comprise a microcontroller.

A state, in particular a vehicle-specific state, can comprise or be characterized by at least one property/parameter which is selected from the group comprising an input magnetic flux, an induced alternating current, a frequency of the induced alternating current, an induced voltage, a frequency of the induced voltage, a rectification current, a rectification voltage, a rectification type, a secondary-sided impedance, a secondary-sided capacity, a required total load voltage, a required total load current, a charging voltage, a charging current, a number of load current outputs, a sensor information, a monitoring output.

The vehicle-specific state management means is not a generic state management means.

In contrast to a generic state management means, the vehicle-specific state management means is adapted to the vehicle or the type of vehicle. The vehicle-specific state management means can e.g. be adapted according to requirements of a vehicle manufacturer.

The vehicle-specific state management means can be implemented differently for different vehicles or sets of vehicles, in particular differently for vehicles of different vehicle types and/or vehicles of different manufacturers. For vehicles of one vehicle type, in particular of one manufacturer, the vehicle-specific state management means can be implemented similarly.

This means that the state control can be performed different for different vehicles, in particular different for vehicles of different vehicle types and/or vehicles of different manufacturers. This e.g. means that functions executed during state control are implemented differently and/or use different parameters. For vehicles of one vehicle type, in particular of one manufacturer, the state control can be performed similar. This e.g. means that functions executed during state control are implemented similar and/or use the same parameters.

In particular, the software or code which is executed in order to control the execution of generic functions is different for multiple secondary units, e.g. of vehicles of different vehicle types and/or manufacturers.

This advantageously allows executing generic functions by vehicle-specific state management means of different vehicle types without the need to adapt or convert the generic functions into a form that is readable by the vehicle-specific state management means of the different vehicle types.

A generic state management means is not adapted to the vehicle or the type of vehicle. However, an execution of generic functions is also controllable or manageable by the at least generic state management means.

The generic-specific state management means can be implemented similarly for vehicles, in particular similarly for vehicles of different vehicle types and/or vehicles of different manufacturers. This means that the state control is similar, in particular performed similar, for different vehicles, in particular similar for vehicles of different vehicle types and/or vehicles of different manufacturers. This e.g. means that functions executed during state control are implemented similarly and/or use the same parameters.

It is possible that an execution of generic functions is controllable or manageable by the vehicle-specific state management means via the generic state management means.

In particular, the software or code which is executed in order to control the execution of generic functions is similar for multiple secondary units, e.g. of vehicles of different vehicle types and/or manufacturers. In other words, the generic state management means is implemented similarly for multiple, in particular different, secondary units. Thus, the generic state management means can be also referred to as secondary unit-specific state management means.

A state management means can denote a means which controls a system behaviour of the secondary unit or a system comprising the secondary unit. In other words, the state management means can control or manage the execution of functions which are e.g. required for performing the inductive power transfer, for performing safety-related operations, for performing a communication of the secondary unit, e.g. with a primary unit, or for performing a foreign object detection or for performing a relative positioning.

In particular, the state management means can provide a state control of vehicle-sided elements, e.g. a user interface of the vehicle and/or elements of the secondary unit. Further, the state management means can provide a scheduled execution of generic functions.

By the state management means, a system behaviour can be controlled based on events, time-dependent conditions and external input signals. Further, the state management means can control the execution of generic functions for the supervision and for the control of secondary-sided processes or operation.

A state sequence and the corresponding decision logic for state changes which are controlled by the state management means can be provided by a state machine or by a flow diagram.

Input signals for the vehicle-specific state management means can have the generic format. Output signals of the vehicle-specific state management means can also have the generic format.

In summary, the system behaviour of the secondary unit and/or systems comprising the secondary unit can be adapted according to vehicle-specific, in particular vehicle type-specific, requirements by providing the vehicle-specific state management means. The desired or required system behaviour is, however, provided by executing generic functions. This advantageously allows a simple adaption of the system behaviour of the secondary unit to a desired vehicle or vehicle type, wherein an adaption effort is minimized.

The at least one vehicle-specific state management means can be provided by at least one control unit, e.g. by at least one microcontroller. In particular, the vehicle-specific state management means can be provided by the same control unit as the secondary-sided means for executing generic functions. The vehicle-specific state management means can e.g. be implemented by software or code, wherein the functionality of the vehicle-specific state management means is provided if the software or code is executed by the at least one control unit.

The at least one vehicle-specific state management means can have or provide an interface for a data transmission between the vehicle-specific state management means and other means, e.g. the secondary-sided means for executing generic functions. Via said interface, data signals with a generic format can be transmitted.

In other words, the generic parts of the proposed secondary unit can be similar for each vehicle. Thus, the vehicle- or application-specific part is reduced to a minimum.

A vehicle-specific and a generic state management means can be provided by software code, wherein the software code provides the functionality of the state management means if the software code is executed by or in an automation system, e.g. by or in a control unit. The software code can comprise software means or software components for the execution of the state management, e.g. for executing state changes. Further, the vehicle-specific and a generic state management means can be provided by a means for executing the software code, e.g. an automation system, more particular a control unit. Further, the vehicle-specific and a generic state management means can be provided by a means for storing the software code, e.g. a memory unit.

A means for executing generic functions can also be provided by software code, wherein the software code can comprise software means or software components for the execution of the generic functions, if the software code is executed by or in an automation system, e.g. by or in a control unit. Further, the means for executing generic functions can be provided by a means for executing the software code, e.g. an automation system, more particular a control unit. Further, the means for executing generic functions can be provided by a means for storing the software code, e.g. a memory unit.

The secondary unit can comprise means for executing and storing the software code, e.g. the secondary-sided control unit. Also the primary unit can comprise means for executing and storing the software code, e.g. a primary-sided control unit.

In another embodiment, the secondary unit comprises at least one interface unit for a data transmission between a secondary unit and the vehicle. It is, for instance, possible that the secondary unit is connected to a communication system of the vehicle via the interface unit. The vehicle communication system can e.g. be a serial communication bus system, in particular a CAN bus system.

Further, a data signal in a vehicle-specific format is convertible to a data signal with a generic format by the interface unit or by the vehicle-specific state management means. The generic format is used by or within the secondary unit for the transmission of information contained in the data signal and/or for the operation control based on the information contained in the data signal. In particular, the generic format denotes a format which is used by or within secondary units of different vehicles, in particular by different vehicles of the same and/or different vehicle types. In other words, the generic format is independent of the vehicle type and/or the manufacturer. The generic format can thus be a proprietary function of the secondary unit, e.g. a format used or defined by the manufacturer of the secondary unit. By the format conversion, a data signals, in particular data signals in a format used or defined by the car manufacturer, can be converted to said proprietary format. This conversion can also be referred to as signal mapping or signal assignment. Said conversion advantageously allows using the generic state management means.

The generic format can be different from the vehicle-specific format. For example, the generic format can have a bit length that is larger than the bit length of each of the compatible vehicle-specific formats or equal to the largest bit length of the compatible vehicle-specific formats.

As a further example, a vehicle-specific format of a first data signal can contain a voltage given in microvolts and another vehicle-specific format of a second data signal can contain a current given in Amperes. The generic format would in this further example be the number value in addition to the measurement unit. The generic format may e.g. comprise one or multiple bit words, each representing a value, a measurement unit, an identification date, a receiving date, a transmitting date, or further dates used to describe the information used in the specific format or vehicle specific format.

Further, a data signal in a generic format is convertible to a data signal with a vehicle-specific format by the interface unit or by the vehicle-specific state management means. Through the use of a mapping algorithm or a mapping function utilizing mapping data, a generic format can be mapped to a vehicle-specific format or vice versa. The mapping function may be part of means for executing generic functions or means for executing vehicle-specific functions. This mapped or converted generic format now uses the bit words of the vehicle-specific format and is used in the generic function to carry out the generic function.

For example for this purpose, a set of mapping functions may be programmed into the secondary-sided control unit and/or the secondary-sided interface unit. Advantageously the generic format may be re-used for mapping it to another vehicle-specific format. Further advantageously, in the case that the generic format is hard coded into an electronic circuit, the electronic circuit or the layout of the electronic circuit may be re-used in a similar or different application environment.

It is possible that a data signal which is transmitted from the vehicle communication system to the secondary unit is converted from the vehicle-specific format to the generic format by the interface unit. The signal can e.g. be an input signal for the vehicle-specific state management means, for a generic function or a trigger signal for a generic function. Further, a data signal which is transmitted from the secondary unit to the vehicle communication system can be converted from the generic format to the vehicle-specific format. Such a signal can e.g. be an output signal of the vehicle-specific state management means or an output signal of a generic function.

The interface unit can be provided by at least one control unit, in particular by a microcontroller. It is possible that the interface unit is provided by the same control unit as the vehicle-specific state management means.

This advantageously further reduces an adaptation effort for adapting the secondary unit to a desired vehicle or vehicle type.

In another embodiment, the secondary unit comprises at least one secondary-sided generic state management means. This generic state management means can also be referred to as base software state management means. The generic state management means is similar for every vehicle or vehicle type. The generic state management means can e.g. control the execution of functions, in particular generic functions, for a shutdown, a wake-up, an initialization and/or a self-testing operation of the secondary unit or of the at least one control unit.

This means that the secondary unit can comprise two state management means, the aforementioned vehicle-specific state management means and the generic state management means. Both state management means can be provided by the same control unit.

This advantageously reduces an adaptation effort as essential functions of the secondary unit or of at least one secondary-sided control unit are controlled or managed by a generic state management means.

The generic state management means can have an interface for data transmission between the generic state management means and other means, e.g. the vehicle-specific state management means and/or the means for executing generic functions and/or the interface unit. Via said interface, data with the generic format can be transmitted.

In another embodiment, a generic function is a charging control function.

In particular, the charging control function can be a charging current control function. The charging current can be a DC current which is provided by the secondary unit, in particular by the rectifier, upon reception of the alternating electromagnetic field which is generated by a primary unit. A set value for the charging current can e.g. be provided by the vehicle, in particular via the interface unit of the secondary unit. During the execution of the charging current control function, the input power of the primary winding structure can be adapted such that an actual charging current is equal to or does not deviate more than a predetermined amount from the set value. In this case, a set value for the input power of the primary winding structure can be determined, e.g. by a secondary-sided control unit or a primary-sided control unit based on the deviation of the actual charging current from the set value of the charging current.

It is also possible to adapt the output power of the secondary-sided rectifier by the execution of the charging current control function in order to adjust the actual charging current such that is equal to or does not deviate more than a predetermined amount from the set value. The output power can be the mathematical product of the DC output current and the DC output voltage of the secondary-sided rectifier. The output power can be adapted by suitable adapting means.

If the set value is determined by a secondary-sided control unit, the set value can be transmitted from the secondary unit to the primary unit, e.g. by executing a communicating control function. If the set value is determined by a primary-sided control unit, an actual value of the charging current and the set value of the charging current can be transmitted from the secondary unit to the primary unit, e.g. via executing a communication control function.

Then, the input power of the primary winding structure can be adapted such that it equals to the set value of the input power or deviates not more than a predetermined amount from said set value. The control of the input power can e.g. be provided by performing an input power control function. This input power control function can e.g. be executed by a primary-sided means for executing generic functions.

The charging control function can also be a charging voltage control function or a charging power control function. In this case, according to the explanations related to the charging current control function, a corresponding set value can be provided and the input power the primary winding structure or the output power of the secondary-sided rectifier can be adjusted accordingly.

In another embodiment, a generic function is a communication control function for controlling or performing a communication between the secondary unit and a primary unit of the system for inductive power transfer. It is possible that the secondary unit comprises a further interface unit for a data transmission between the secondary unit and the primary unit. In this case, the primary unit can also comprise a corresponding interface unit. The interface unit can be provided by a control unit, e.g. by the same control unit as the secondary-sided means for executing generic functions. By executing a communication control function, a data transmission between the primary unit and the secondary unit can be performed. In other words, a communication link can be established between the primary unit and the secondary unit. Via said data transmission, signals, e.g. input signals, output signals or trigger signals, which are generated by secondary-sided means can be transmitted to primary-sided means and vice versa.

An input to the communication control function can e.g. be a data signal in the generic format which is to be transmitted to or from the primary unit. An output of the communication control function can e.g. be a set value for a voltage generator which provides a voltage applied to an antenna element. It is thus possible to control the sending power of the antenna element within a wireless communication between the secondary unit to the primary unit.

The communication between the secondary unit and the primary unit can be a wireless communication.

In another embodiment, a generic function is a positioning control function for controlling a relative positioning between a secondary winding structure of the secondary unit and a primary winding structure of a primary unit.

In order to achieve a desired efficiency of the inductive power transfer, it is desirable to position the secondary winding structure above the primary winding structure. In other words, a reference point of the secondary winding structure, e.g. a geometric centre, should be positioned within a certain position range above a corresponding reference point of the primary winding structure, e.g. a geometric centre of the primary winding structure.

It is, for instance, possible that a position of the primary unit in a global reference coordinate system is determined, e.g. by a primary-sided position sensing means or is predetermined, e.g. by a calibration procedure which is performed before an operation of the primary unit. Depending on this position, a position of the primary winding structure can be determined. This position can be transmitted to the secondary unit, e.g. by executing a communication control function. Further, a vehicle position in the global reference coordinate system can be determined by a vehicle-sided position sensing means. This vehicle position can be transmitted from the vehicle to the secondary unit, e.g. via the aforementioned interface unit. Depending on the vehicle position, a position of the secondary winding structure can be determined. Then, a relative position between the primary winding structure and the secondary winding structure can be determined. If the relative position deviates from a desired relative position more than a predetermined amount, the positioning control function can generate an output signal, wherein the output signal can be used to control an automatic positioning of the vehicle or in order to control a user interface such that positioning information are provided to a vehicle driver.

Said output signal can e.g. be transmitted to the vehicle communication system, e.g. via the aforementioned interface unit.

In another embodiment, a generic function is a safety function. A safety function is e.g. defined in the industrial standard ISO 26262, edition 1, parts 1 to 9 published in November 2011 and part 10 published in August 2012 which is hereby fully incorporated by reference. A safety function can denote a function by which an operational safety of the secondary unit, the vehicle and/or the system for inductive power transfer comprising the secondary unit is ensured. As one example, by executing the safety function, a short circuit of the secondary winding structure can be detected. If such a short circuit is detected, the safety function can generate an output signal which triggers a termination of the inductive power transfer.

In another embodiment, at least a part of a generic function is executed by a primary-sided means for executing generic functions. This means that the execution of a generic function can be distributed among a secondary-sided means and a primary-sided means.

The primary-sided means for executing generic functions can be provided by a primary-sided control unit, e.g. a primary-sided microcontroller.

Especially in this embodiment, the secondary unit can comprise the aforementioned further interface unit for a data transmission between the secondary unit and the primary unit.

As explained before, the charging current control function can be partially executed by the secondary-sided means and partially by the primary-sided means. In particular, the secondary-sided means can determine the deviation between an actual charging current and the set value for the charging current. The primary-sided means can determine the deviation between an actual input power and the set value of the input power, wherein the set value of the input power can be determined depending on the deviation between the actual charging current and the set value of the charging current.

This advantageously allows reducing a computational workload for the secondary unit, in particular for a secondary-sided control unit.

In another embodiment, an execution of generic functions by a primary-sided means for executing generic functions is controllable by the vehicle-specific state management means. In this embodiment, input and output signals for/of the vehicle-specific state management means can be transmitted between the primary and the secondary unit via the further interface unit for the data transmission between the primary and the secondary unit.

Further proposed is a system for inductive power transfer to a vehicle. The system comprises a primary unit. The primary unit can comprise a primary winding structure for generating an alternating electromagnetic field. Further, the primary unit can comprise a power converter for providing an alternating input voltage for the primary winding structure and a desired input power of the primary winding structure. Further, the primary unit can comprise at least one primary-sided control unit, in particular a microcontroller.

Further, the system can comprise a secondary unit according to one of the embodiments described in this disclosure. Further, the primary unit comprises at least one primary-sided means for executing generic functions. Further, the primary unit comprises no means for executing vehicle-specific functions. In other words, the primary unit is designed fully independent of vehicles to which energy is supplied inductively by the primary unit and vehicle-specific requirements.

In other words, the adaption of the system behaviour of the proposed system for inductive power transfer is exclusively provided by the secondary-sided vehicle-specific state management means and, if applicable, by the secondary-sided interface unit. This can especially mean that no data signals with the vehicle-specific format are transmitted to the primary unit.

In another embodiment, the primary unit comprises at least one primary-sided generic state management means. In particular, the primary unit does not comprise any vehicle-specific state management means.

Further, the primary unit can comprise two generic state management means, wherein a first generic state management means can control the execution of generic functions which provide or characterize the system behaviour of the primary unit. A further state management means can provide a base software state management means, wherein said base software state management means can e.g. control the execution of base functions such as wake-up function, initialization function, shutdown function or self-testing function of the primary unit or of a primary-sided control unit.

This advantageously further reduces the adaptation effort of the system for inductive power transfer to different vehicles or different types of vehicles, in particular as no vehicle-specific adaptation of the primary unit is necessary.

In another embodiment, the primary unit comprises an interface unit for a data transmission between the primary unit and the secondary unit. This and corresponding advantages have been explained before.

Generic functions which are executed by the primary-sided means for executing generic functions can e.g. be a communication control function or a part thereof, a part of the charging current control function, a part of the positioning control function and a safety function or a part thereof.

Further proposed is a method for controlling an operation of a secondary unit of a system for inductive power transfer to a vehicle.

According to the invention, a vehicle-specific state management means controls the execution of generic functions, wherein the generic functions are executed by at least one secondary-sided means for executing generic functions.

The proposed method can be performed by a secondary unit according to one of the embodiments described in this disclosure. Thus, the secondary unit is designed such that a method for controlling an operation of a secondary unit of a system for inductive power transfer to a vehicle according to one of the embodiments disclosed in this disclosure can be performed by the secondary unit.

Further described is a data processing system of a system for inductive power transfer, in particular of the secondary unit, wherein the data processing system comprises means for the execution of a method for controlling an operation of a secondary unit of a system for inductive power transfer to a vehicle according to one of the embodiments disclosed in this disclosure. The data processing system can e.g. comprises a secondary-sided and/or primary-sided control unit.

Further described is a computer program product with a computer program, wherein the computer program comprises software means for the execution of a method for controlling an operation of a secondary unit of a system for inductive power transfer to a vehicle according to one of the embodiments disclosed in this disclosure, if the computer program is executed by or in an automation system, e.g. a control unit.

Further described is a program which, when running on a computer, causes the computer to perform one or more or all steps of a method for controlling an operation of a secondary unit of a system for inductive power transfer to a vehicle according to one of the embodiments described herein and/or to a program storage medium on which the program is stored (in particular in a non-transitory form) and/or to a computer comprising said program storage medium and/or to a (physical, for example electrical, for example technically generated) signal wave, for example a digital signal wave, carrying information which represents the program, for example the aforementioned program, which for example comprises code means which are adapted to perform any or all of the method steps described herein.

This means that the method in accordance with the invention is for example a computer implemented method. For example, all the steps or merely some of the steps (i.e. less than the total number of steps) of the method in accordance with the invention can be executed by a computer. An embodiment of the computer implemented method is a use of the computer for performing a data processing method. The computer for example comprises at least one processor and for example at least one memory in order to (technically) process the data, for example electronically and/or optically. The processor being for example made of a substance or composition which is a semiconductor, for example at least partly n- and/or p-doped semiconductor, for example at least one of II-, III-, IV-, V-, VI-semiconductor material, for example (doped) silicon and/or gallium arsenide. The calculating steps described are for example performed by a computer. Determining steps or calculating steps are for example steps of determining data within the framework of the technical method, for example within the framework of a program. A computer is for example any kind of data processing device, for example electronic data processing device. A computer can be a device which is generally thought of as such, for example desktop PCs, notebooks, netbooks, etc., but can also be any programmable apparatus, such as for example a mobile phone or an embedded processor. A computer can for example comprise a system (network) of “sub-computers”, wherein each sub-computer represents a computer in its own right.

In particular, the vehicle-specific state management means can generate output signals, in particular in a generic format, wherein these output signals provide input signals for generic functions or provide trigger signals for the execution of at least one generic function. The vehicle-specific state management means can control the execution of the generic function depending on events, e.g. provided as input signals, in particular input signals with the generic format. These input signals can e.g. be provided by output signals of generic functions or by a vehicle communication system.

Such a method advantageously allows a control of the operation of the secondary unit with a desired system behaviour while adaptation effort of the secondary unit to vehicle-specific requirements is reduced.

In another embodiment, at least one data signal is transmitted between the secondary unit and the vehicle, wherein a data signal in a vehicle-specific format is converted to a data signal with a generic format by an interface unit of the secondary unit, wherein a data signal in a generic format is converted to a data signal with a vehicle-specific format by the interface unit of the secondary unit. This and corresponding advantages have been explained before.

In another embodiment, a secondary-sided generic state management means controls the execution of generic functions. In particular, the secondary-sided generic state management means can control the execution of base functions for performing a shutdown, a wake-up, an initialization and/or a self-testing operation of secondary-sided elements, e.g. control units. This and corresponding advantages have been explained before.

In another embodiment, a generic function is a charging control function or a communication control function for controlling a communication between the secondary unit and a primary unit of the system for inductive power transfer or a positioning control function for controlling a relative positioning between a secondary winding structure of the secondary unit and a primary winding structure of a primary unit or a safety function. This and corresponding advantages have been explained before. The charging control function can be a charging current control function, a charging voltage control function or a charging power control function.

In another embodiment, a primary-sided means for executing generic functions executes at least a part of a generic function, in particular one or more sub-function/s. In this case, another part, in particular the remaining part, of the generic function can be executed by the secondary-sided means for executing generic functions, in particular one or more sub-function/s. This advantageously allows the distribution of the execution between the primary unit and the secondary unit. This and corresponding advantages have been explained before.

In another embodiment the vehicle-specific state management means controls the execution of generic functions by a primary-sided means for executing generic functions. This and corresponding advantages have been explained before.

As explained before, there can exist a vehicle-specific state management means, a secondary-sided generic state management means (secondary unit-specific state management means) and a primary-sided generic state management means (primary unit-specific state management means).

For example, to initiate the charging process of an inductive charging system, the driver of a vehicle can operate a user interface for initiating the charging process. The user interface generates a vehicle-specific charging signal, i.e. a signal with a vehicle-specific format, and transmits said signal to the secondary unit, for example via the internal CAN-bus of the vehicle.

The secondary unit receives the vehicle-specific charging signal. The vehicle-specific charging signal can be converted to a charging signal with a generic format, in particular by the aforementioned interface unit, e.g. by using a mapping algorithm or function. Further, an execution of generic functions, in particular of a charging control function can be initiated, e.g. by the vehicle-specific state management means.

By the execution of generic functions, a charging permissibility can be tested, e.g. by testing if the secondary unit is correctly positioned relative to the primary unit and/or by testing if a communication link between the primary and the secondary unit is successfully established.

Further, by the execution of the generic functions, signals can be transmitted between the secondary and the primary unit. It is, for instance possible to generate a generic output signal for communication with the primary side. However, other signal paths, mappings and uses are possible. Such a signal can e.g. be a start signal for a charging operation of the primary unit.

Further, by the execution of the generic functions, a charging operation of the primary unit can be executed or controlled. It is, for instance, possible to provide an adequate input power to the primary winding structure by executing generic functions.

Further, the secondary-side-specific state management means may convey the vehicle-specific signal from the vehicle-specific state management means to the primary side where the format mapping is then carried out internally in the primary-side-state management means and the generic signal generated by the primary-side-specific means is then used in the internal control processes.

Further proposed is a method for controlling an operation of a system for inductive power transfer. The system comprises a primary unit and a secondary unit according to one of the embodiments described in this disclosure. The primary unit comprises at least one primary-sided means for executing generic functions. A vehicle-specific state management means controls the execution of generic functions. Further, the generic functions are executed at least partially by at least one secondary-sided means for executing generic functions and/or at least partially by at least one primary-sided means for executing generic functions.

The proposed system advantageously allows operating the system of inductive power transfer with a desired vehicle-specific system behaviour while minimizing the effort for adapting the system to vehicle-specific requirements of the system behaviour.

Further described is a data processing system of a system for inductive power transfer wherein the data processing system comprises means for the execution of a method for controlling an operation of a system for inductive power transfer according to one of the embodiments disclosed in this disclosure. The data processing system can e.g. comprise a secondary-sided and/or primary-sided control unit.

Further described is a computer program product with a computer program, wherein the computer program comprises software means for the execution of a method for controlling an operation of a system for inductive power transfer according to one of the embodiments disclosed in this disclosure, if the computer program is executed by or in an automation system, e.g. a control unit. Further described is a program which, when running on a computer, causes the computer to perform one or more or all steps of a method for controlling an operation of a system for inductive power transfer according to one of the embodiments described herein and/or to a program storage medium on which the program is stored (in particular in a non-transitory form) and/or to a computer comprising said program storage medium and/or to a (physical, for example electrical, for example technically generated) signal wave, for example a digital signal wave, carrying information which represents the program, for example the aforementioned program, which for example comprises code means which are adapted to perform any or all of the method steps described herein.

Further proposed is a vehicle fleet of at least two vehicle types. Each vehicle type comprises at least one vehicle with an electrical system and a secondary unit according to one of the embodiments described in this invention. An output power of the secondary unit can be provided to the electrical system of the vehicle. The electrical system can e.g. comprise a battery or an accumulator.

Further, the electrical system of vehicles of different vehicle types has at least one different property or characteristic.

According to the invention, a vehicle-specific state management means is implemented differently for vehicles of different vehicle types. Further, the vehicle-specific state management means can be implemented similarly for vehicles of the same vehicle type.

In particular, the vehicle-specific state management means can control the execution of at least one generic function, e.g. for controlling an operation of the electrical system, such that generic functions executed on vehicles of different vehicle types use or require an individual, i.e. vehicle type-specific, set of parameters or sub-set of the set of parameters.

By controlling the operation of the electrical system with a generic function that uses a set of parameters that differ for each vehicle type, advantageously no vehicle-specific functions need to be implemented. This further advantageously allows to greatly reduce the costs during the design process as well as in each maintenance circle of each vehicle of the vehicle fleet.

In another embodiment, at least one property or at least one parameter required for the execution of a generic function is selected from the group of elements comprising an input magnetic flux, an induced alternating current, a frequency of the induced alternating current, an induced voltage, a frequency of the induced voltage, a rectification current, a rectification voltage, a rectification type, a secondary-sided impedance, a secondary-sided capacity, a required total load voltage, a required total load current, a number of load current outputs, a sensor information about a component of the vehicle, a monitoring output of a set of sensor information about at least one component of the vehicle and a temperature.

In another embodiment, the electrical system of each vehicle comprises a battery.

In another embodiment, a primary unit is proposed, wherein a primary-sided generic state management means controls the execution of generic functions, wherein the generic functions are executed by at least one primary-sided means for executing generic functions. In particular, there is no vehicle-specific and primary-sided state management means. This and corresponding advantages have been explained before.

Further, data signals are transmitted between the primary unit and the secondary unit. The data signals can be transmitted in order to trigger or in order to execute certain generic functions.

The invention will be described with reference to the attached figures. The figures show:

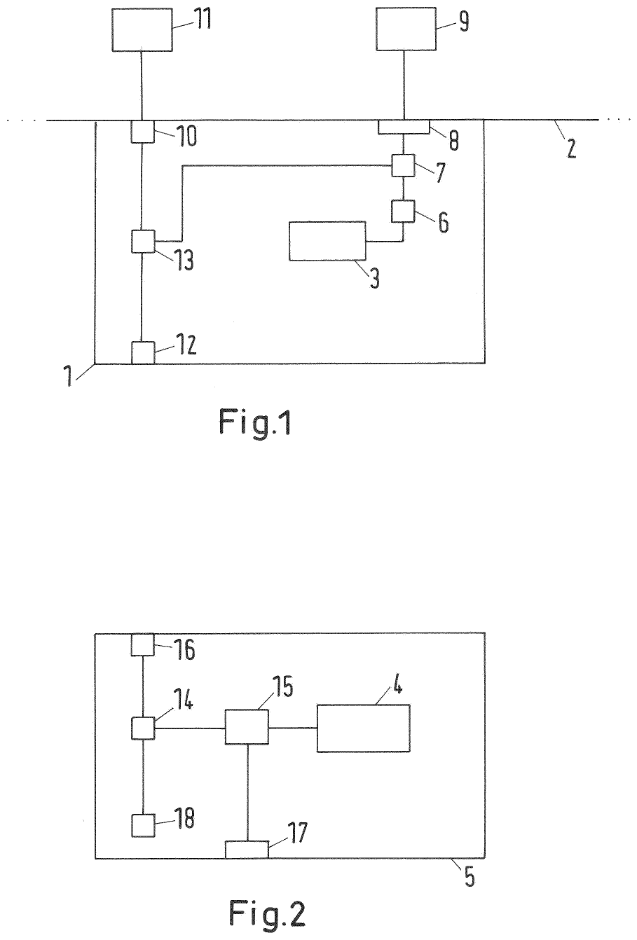

FIG. 1 a schematic block diagram of a secondary unit of a system for inductive power transfer,

FIG. 2 a schematic block diagram of a primary unit of a system for inductive power transfer,

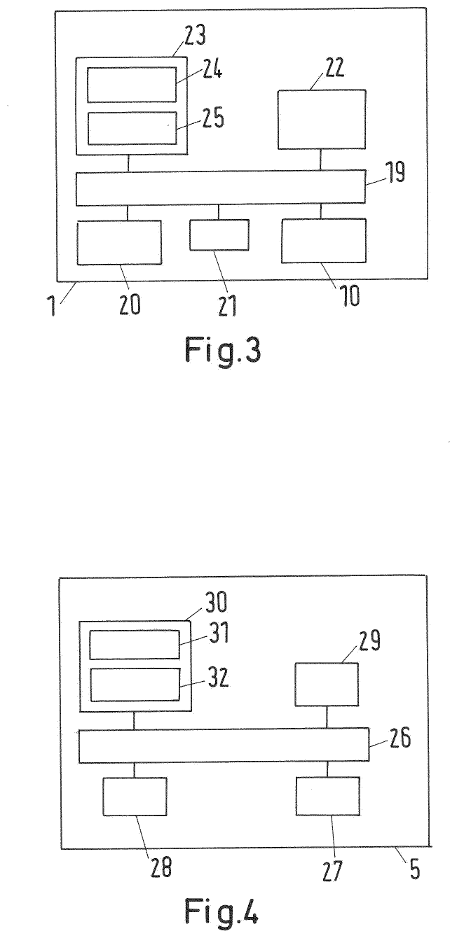

FIG. 3 a functional layout scheme of a secondary unit of a system for inductive power transfer and

FIG. 4 a functional layout scheme of a primary unit of a system for inductive power transfer.

In the following, the same reference numerals denote elements with the same or similar technical features.

FIG. 1 shows a schematic block diagram of a secondary unit 1 of a system for inductive power transfer to a vehicle 2. The secondary unit 1 comprises a secondary winding structure 3 for receiving an alternating electromagnetic field which is generated by a primary winding structure 4 (see FIG. 2) of a primary unit 5. Further, the secondary unit 1 comprises a rectifier 6, a current sensor 7 and a power interface 8 for electrically connecting the secondary unit 1 to a vehicle DC-link, to which at least a portion of an electric system of the vehicle, in particular a portion providing a traction system or a part thereof, a portion comprising a battery and/or other electric or electrical components is electrically connected. Further shown is a traction battery 9 of the vehicle 2, wherein the traction battery 9 is connected to the power interface 8 of the secondary unit 1.

The secondary unit 1 further comprises a first secondary-sided interface unit 10 for a data transmission between the secondary unit 1 and the vehicle 2. It is shown that the first interface unit 10 is connected to a communication system 11 of the vehicle 2, in particular a CAN bus system. Further, the secondary unit 1 comprises a second secondary-sided interface unit 12 for a data transmission between the secondary unit 1 and the primary unit 5.

Further, the secondary unit 1 comprises a secondary-sided control unit 13 which can e.g. comprise or be designed as a microcontroller. The secondary-sided control unit 13 can comprise or provide the interface units 10, 12. Further, the secondary-sided control unit 13 can be linked to the current sensor 7.

The secondary-sided control unit 13 provides a vehicle-specific state management means which controls an execution of generic functions. The generic functions or a part thereof can be executed by the secondary-sided control unit 13 of the secondary unit 1 or by a primary-sided control unit 14 of the primary unit 5 (see FIG. 2).

Generic functions denote functions which are identical with respect to a set of used parameters for multiple secondary units 1 which are attached to different vehicles 2. Thus, the implementation and provision of the generic functions are independent of the vehicle 2 to which the secondary unit 1 is attached.

It is further possible that the secondary-sided control unit 13 generates a data signal in a generic format which is to be transmitted to the communication system 11 of the vehicle 2. This data signal in the generic format is converted into a data signal with a vehicle-specific format, in particular a format adapted for the transmission via the CAN bus system by the first interface unit 10. Further, a data signal in a vehicle-specific format which is transmitted from the vehicle communication system 11 to the secondary-sided control unit 13 can be converted into a data signal with the generic format by the first interface unit 10.

The vehicle-specific state management means is adapted to provide a vehicle-specific system behavior of the secondary unit 1 or a system comprising the secondary unit 1, in particular a system for inductive power transfer to the vehicle 2 which comprises the secondary unit 1 and the primary unit 5 (see FIG. 2). In order to provide the desired system behavior, the vehicle-specific state management means can control the execution of generic functions. This control can be in parts provided by a control of a generic state management means.

The vehicle-specific state management means can e.g. provide an output signal upon a state change, wherein the output signal triggers the execution of at least one generic function or provides an input for at least one generic function. Further, the secondary-sided control unit 13 can generate a data signal in a generic format which is to be transmitted to the primary unit 5. Transmission can be performed using the further interface unit 12.

FIG. 2 shows a schematic block diagram of a primary unit 5. The primary unit 5 comprises the primary winding structure 4, the primary-sided control unit 14, a power converter 15, and a first primary-sided interface unit 16 for the data transmission between the secondary unit 1 (see FIG. 1) and the primary unit 5. Further shown is a power interface 17 of the primary unit 5 by which the primary unit 5 can be connected to an external power grid.

The primary-sided control unit 14 can provide a generic state management means and a primary-sided means for executing generic functions.

An exemplary generic function which is executed by the primary-sided and the secondary-sided control units 13, 14 is a charging current control function. By executing this charging current control function, the secondary-sided control unit 13 can read out the current measured by the current sensor 7, e.g. by performing a generic readout function. The current which is measured by the current sensor 7 corresponds to a DC current provided by the rectifier 6. Said current corresponds to the charging current which can e.g. be used for charging the traction battery 9. A control system of the vehicle 2 can e.g. determine a set value for a desired charging current, wherein the set value is provided to the secondary-sided control unit 13 via the communication system 11 of the vehicle 2 and the first interface unit 10. In this case, the set value can be encoded by a data signal with a vehicle-specific format. The first interface unit 10 can convert said data signal into a data signal with a generic format.

The secondary-sided control unit 13 can determine a deviation between the set value and the actual current value which is provided by the current sensor 7, e.g. by performing another generic function or a sub-function. Said deviation can be encoded into a data signal which is transmitted to the primary-sided control unit 14 via the interface units 12, 16. Said data signal can have a generic format. Based on said deviation, the primary-sided control unit 14 can determine a desired input power of the primary winding structure 4, e.g. by executing a generic function or a sub-function. Further, the primary-sided control unit 14 can determine or measure the actual input power provided by the converter 15. Based on the deviation between the desired input power and the actual input power, the primary-sided control unit can control an operation of the power converter 15 such that the deviation between the desired and actual input power of the primary winding structure 4 is reduced, in particular to zero, e.g. by executing another generic function or a sub-function.

The vehicle-specific state management means can control a corresponding change of states for initiating and during the execution of the charging current control function. In a first state, the desired set value of the charging current can be requested by the secondary-sided control unit 13. In a second state, e.g. after reception of said desired charging current, an actual charging current can be read out from the current sensor 7. Upon reception of the read-out value, a state change to a third state can be performed. In the third state, the deviation between the desired and actual charging current can be determined. In a fourth state, e.g. after the deviation has been determined, said deviation can be transmitted to the primary-sided control unit 14. In a fifth state, e.g. after the transmission has been performed, a desired input power of the primary winding structure 4 can be determined based on the deviation between the desired and actual charging current. In a sixth state, e.g. after the desired input power has been determined, an actual input power can be read out or determined by the primary-sided control unit 14. In a seventh state, e.g. after the actual input power has been determined, the power converter 15 can be controlled by the primary-sided control unit 14 such that the deviation between the desired input power and the actual input power is minimized.

Within the execution of the charging current control function, another generic function can be executed, namely a communication control function. By executing a communication control function, a data signal can be generated on the primary side or on the secondary side and is transmitted to the respectively other side.

The primary unit 5 further comprises a GPS sensor 18, wherein a position of the primary unit 5 in a global reference system can be measured by the GPS sensor 18.

The vehicle 2 can also comprise a GPS sensor (not shown), wherein the position of the vehicle 2 in the global reference coordinate system can be determined by the vehicle-sided GPS sensor. As the secondary unit 1 is mechanically fixed to the vehicle 2 and the secondary winding structure 3 is fixedly arranged within the secondary unit 1, this allows determining the position of the secondary winding structure 3 in the global reference coordinate system. The GPS sensor 18, in particular its output signal, allows determining the position of the primary winding structure 4 in the global reference coordinate system.

These sets or pieces of positioning information obtained by the GPS Sensor 18 can be used for performing another generic function, namely a positioning control function for controlling a relative positioning between the secondary winding structure 3 and the primary winding structure 4.

FIG. 3 shows a functional layout scheme of the secondary unit 1. Shown is a run time environment 19 of the secondary unit 1 which can e.g. be an AutoSAR run time environment. The run time environment 19 controls an interaction between services of a service layer, hardware of a hardware layer and software components. It is shown that the secondary unit 1 comprises a control unit state manager 20 which controls the execution of a wake-up function of the secondary-sided control unit 13 (see FIG. 1). Further, the secondary unit 1 comprises driver components 21 which are provided by generic drivers or generic driver functions. These driver components allow operating hardware components such as the current sensor 7. Further shown is the first interface unit 10 which allows the signal connection to the vehicle communication system 11 (see FIG. 1).

Further shown is a first software component 22 which encodes generic functions. If the code of said first software component 22 is executed, e.g. by the secondary-sided control unit 13 and/or the primary-sided control unit 14 (see FIG. 1 and FIG. 2) a desired generic function can be executed. Further shown is a second software component 23. This second software component 23 encodes a vehicle-specific state manager 24 and a generic state manager 25. If the code of the vehicle-specific state manager 24 is executed, e.g. by the secondary-sided control unit 13, state changes to achieve a desired system behaviour can be controlled, e.g. by controlling the execution of generic functions encoded by the first software component 22.

The execution of said generic functions can also be controlled if the code of the generic state manager 25, which can also be referred to as a base software state manager 25, is executed, e.g. by the secondary-sided control unit 13 (see FIG. 1).

FIG. 4 shows a functional layout scheme of a primary unit 5. The primary unit 5 can also comprise a run time environment 26, wherein the run time environment 26 can be provided by the so-called AutoSAR run time environment. Further, the primary unit 5 can comprise driver components 27 and a control unit state manager 28. Further, the primary unit 1 can comprise a first software component 29 which encodes generic functions. These generic functions can be executed if the code of the first software component 29 is executed by the primary-sided control unit 14 and/or the secondary-sided control unit 13. Further shown is that the primary unit 5 comprises another software component 30 which comprises a generic state manager 31 and a base software state manager 32. If the code of said software components 31, 32 is executed, e.g. by the primary-sided control unit 14, a desired system behaviour of the primary unit 5 can be achieved.

### REFERENCE SIGNS

1 secondary unit
2 vehicle
3 secondary winding structure
4 primary winding structure
5 primary unit
6 rectifier
7 current sensor
8 power interface
9 traction battery
10 first interface unit
11 communication system
12 further interface unit
13 secondary-sided control unit
14 primary-sided control unit
15 power converter
16 interface unit
18 GPS sensor
20 control unit state manager
21 driver components
22 first software component
23 second software component
24 vehicle-specific state manager
25 generic state manager, base software state manager
26 run time environment
27 driver components
28 control unit state manager
29 first software component
30 software component
31 generic state manager
32 base software state manager

1.-26. (canceled)

27. A secondary unit of an inductive power transfer system for electrically powering a vehicle, the secondary unit comprising:
at least one secondary-sided means for executing at least one generic function,
wherein a generic function is identical with respect to a set of parameters used for the execution of the generic function in multiple, different secondary units or in multiple, different vehicles, wherein the secondary unit comprises at least one vehicle-specific state management means which is adapted to the vehicle or the type of vehicle, wherein an execution of the at least one generic function is controllable by the at least one vehicle-specific state management means.

28. The secondary unit of claim 27, wherein the secondary unit comprises at least one interface unit for a data transmission between the secondary unit and the vehicle, wherein a data signal in a vehicle-specific format is convertible to a data signal with a generic format by the interface unit or by the vehicle-specific state management means, wherein a data signal in a generic format is convertible to a data signal with a vehicle-specific format by the interface unit or by the vehicle-specific state management means.

29. The secondary unit of claim 27, wherein the secondary unit comprises at least one secondary-sided generic state management means.

30. The secondary unit of claim 27, wherein a generic function is a charging control function and/or a communication control function for controlling a communication between the secondary unit and a primary unit of the system for inductive power transfer and/or a positioning control function for controlling a relative positioning between a secondary winding structure of the secondary unit and a primary winding structure of a primary unit and/or a safety function.

31. The secondary unit of claim 27, wherein at least a part of a generic function is executed or executable by a primary-sided means for executing generic functions.

32. The secondary unit of claim 27, wherein an execution of generic functions by a primary-sided means is controllable by the vehicle-specific state management means.

33. A system for inductive power transfer to a vehicle, comprising:
a primary unit; and
a secondary unit according to claim 27,
wherein the primary unit comprises at least one primary-sided means for executing generic functions, wherein a generic function is identical with respect to a set of parameters used for the execution of the generic function in multiple, different secondary units or in multiple, different vehicles.

34. The system according to claim 33, wherein the primary unit comprises at least one primary-sided generic state management means.

35. The system according to claim 33, wherein the primary unit comprises an interface unit for a data transmission between the primary unit and the secondary unit.

36. A method for controlling an operation of a secondary unit of a system for inductive power transfer to a vehicle, comprising:
controlling execution of generic functions using a vehicle-specific state management means adapted to the vehicle or the type of vehicle, wherein a generic function is identical with respect to a set of parameters used for the execution of the generic function in multiple, different secondary units or in multiple, different vehicles, wherein the generic functions are executed by at least one secondary-sided means for executing generic functions.

37. The method according to claim 36, further comprising transmitting at least one data signal between the secondary unit and the vehicle, wherein a data signal in a vehicle-specific format is converted to a data signal with a generic format by an interface unit of the secondary unit, wherein a data signal in a generic format is converted to a data signal with a vehicle-specific format by the interface unit of the secondary unit.

38. The method according to claim 36, wherein a secondary-sided generic state management means controls the execution of generic functions.

39. The method of claim 36, wherein a generic function is a charging current control function or a communication control function for controlling a communication between the secondary unit and a primary unit of the system for inductive power transfer or a positioning control function for controlling a relative positioning between a secondary winding structure of the secondary unit and a primary winding structure of a primary unit or a safety function.

40. The method of claim 36, wherein a primary-sided means for executing generic functions executes at least a part of a generic function.

41. The method of claim 36, wherein the vehicle-specific state management means controls the execution of generic functions by a primary-sided means.

42. A method for controlling an operation of a system for inductive power transfer, wherein the system comprises a primary unit, wherein the system further comprises a secondary unit according to claim 27, the method comprising:
executing generic functions at least partially by the at least one secondary-sided means for executing generic functions and/or at least partially by at least one primary-sided means for executing generic functions,
wherein the primary unit comprises the at least one primary-sided means for executing the generic functions, wherein a generic function is identical with respect to a set of parameters used for the execution of the generic function in multiple, different secondary units or in multiple different vehicles, wherein a secondary-sided vehicle-specific state management means which is adapted to the vehicle or the type of vehicle controls the execution of generic functions.

43. The method according to claim 42, wherein a primary-sided generic state management means controls the execution of generic functions, wherein the generic functions are executed by at least one primary-sided means for executing generic functions.

44. The system according to claim 42, further comprising transmitting data signals between the primary unit and the secondary unit.

45. A vehicle fleet of at least two vehicle types, wherein each vehicle type comprises at least one vehicle with an electrical system and a secondary unit according to claim 27, wherein the electrical systems of vehicles of different vehicle types have at least one different parameter, wherein a vehicle-specific state management means which is adapted to the vehicle or the type of vehicle is implemented differently for vehicles of different vehicle types.

46. The vehicle fleet according to claim 45, wherein at least one parameter required for the execution of at least one generic function is selected from the group of elements comprising an input magnetic flux, an induced alternating current, a frequency of the induced alternating current, an induced voltage, a frequency of the induced voltage, a rectification current, a rectification voltage, a rectification type, a secondary-sided impedance, a secondary-sided capacity, a required total load voltage, a required total load current, a number of load current outputs, a sensor information about a component of the vehicle, a monitoring output of a set of sensor information about at least one component of the vehicle and a temperature.

47. The vehicle fleet according to claim 45, wherein the electrical system comprises a battery.

48. A primary unit of an inductive power transfer system for transmitting power to a vehicle, comprising:
a primary-sided generic state management means for controlling the execution of generic functions, wherein the generic functions are executed by at least one primary-sided means for executing generic functions, wherein a generic function is identical with respect to a set of parameters used for the execution of the generic function in multiple, different secondary units or in multiple different vehicles.
